(19) United States
(12) Patent Application Publication
(10) Pub. No.: US 2024/0378180 A1
(43) Pub. Date: Nov. 14, 2024

(54) METHODS AND SYSTEMS FOR DATA FILTERING

(71) Applicant: Bank of America Corporation, Charlotte, NC (US)

(72) Inventors: Harinath Meedinti Bhaskara Reddy, Charlotte, NC (US); Aeric Solow, Richardson, TX (US); Jayachandra Varma, Irvington, TX (US); Manu Kurian, Dallas, TX (US)

(21) Appl. No.: 18/195,986

(22) Filed: May 11, 2023

(51) Int. Cl. G06F 16/215; G06F 16/23

(52) U.S. Cl. CPC G06F 16/215; G06F 16/2365

(57) ABSTRACT

There is provided a method for increasing available memory in an edge layer of a network, where the network stores data and has a default retention period for datasets. The method may include the steps of: (a) receiving the dataset by the edge layer of the network; (b) analyzing the dataset by the front-end filter to identify disposable data points in the dataset, (c) instructing a computer processor to remove the disposable data points from the dataset, upon passage of a specified time interval.

### FIELD OF TECHNOLOGY

Aspects of the disclosure relate to front-end data filtering methods and systems.

### BACKGROUND OF THE DISCLOSURE

Large institutions, for example commercial institutions, often must receive, process, and integrate vast quantities of data on an ongoing basis. Doing so can place a great strain on computing resources, for example bandwidth of critical data channels in the platform layer that are used to transport data within the network.

Moreover, edge layers of computer networks have finite capacities. An ongoing influx of very large quantities of data can overload the edge layer capacity. Discarding data to save hardware or software memory space is often not a good option, given that meticulous record keeping is a necessity for many types of commercial institutions. Maintaining excess memory or storage capacity in computer hardware, and/or excess bandwidth capacity, may prevent or address many of these issues, but it can cause an unnecessary drain on financial and other resources.

These competing considerations can force institutions to make difficult decisions about the fate of datasets. Therefore, there exists a need for improved data management and data channel utilization.

### SUMMARY OF THE DISCLOSURE

It is an object of this invention to reduce strain on edge-layer and/or platform-layer data channels.

It is a further object of this invention to free hardware memory space in edge layers of computer networks.

It is a further object of this invention to increase available memory and/or storage capacity in edge layers of computer networks.

It is a further object of this invention to reduce data burden on edge layers and/or platform layers of computer networks.

A method in accordance with principles of the disclosure may be implemented by a computer and/or be automated.

A method in accordance with principles of the disclosure may utilize a computer processor, a front-end filter, and/or one or more non-transitory computer-readable media storing computer executable instructions. The instructions, when executed by the computer processor and/or front-end filter, may automatically analyze and/or process edge-layer data, e.g., in order to improve system functionality, as described herein.

The method may include the steps of:
receiving a dataset in an edge layer of a network,
analyzing the dataset via the front-end filter, to identify deprioritized data points in the dataset;
subtracting the deprioritized data points from the dataset, thus generating a trimmed dataset; and
transferring the trimmed dataset to the platform layer.

The method may facilitate data transfer into a platform layer of a network.

In some aspects, a computer processor may orchestrate some or all the aforementioned steps.

By this method, network memory capacity (which may be hardware and/or software) and data channel utilization may be optimized and/or more intelligently utilized.

Embodiments of the system, as described herein, leverage front-end filters, and/or other complex, specific-use computer systems to provide a novel approach for improving utilization of edge-layer hardware memory and storage and/or platform-layer data channels.

As such, the present disclosure provides a technical solution to a technical problem of strain on the capacities of data storage and memory and platform-layer data channels.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure.

FIG. 2 shows an illustrative system in accordance with principles of the disclosure.

FIG. 3 is a diagram depicting aspects of a data filtering process, in accordance with embodiments of the disclosure.

FIG. 4 is a diagram depicting aspects of a data filtering process and system, in accordance with embodiments of the disclosure.

FIG. 5 is a diagram depicting aspects of a data filtering and replacement process, in accordance with embodiments of the disclosure.

FIG. 6 is a diagram depicting the temporal fate of datasets after filtering by front-end filter, in accordance with embodiments of the disclosure. Timelines are indicated by large arrows.

FIG. 7A is a diagram depicting the temporal fate of a dataset in the absence of data filtering. The large arrow is a timeline.

FIG. 7B is a diagram depicting the temporal fate of a dataset after filtering by a front-end filter, in accordance with embodiments of the disclosure. The large arrow is a timeline.

FIG. 7C is a diagram depicting the temporal fate of a dataset after filtering by front-end filter, in accordance with embodiments of the disclosure. The large arrow is a timeline.

### DETAILED DESCRIPTION OF THE DISCLOSURE

Systems and methods are described for leveraging front-end filters, computer processors, and/or other complex, specific-use computer systems to provide a novel approach for improving utilization of edge-layer hardware memory and storage and/or platform-layer data channels, e.g., via selective dropping, or deletion, of raw data from data packages received by a network. The raw data may be sourced from a customer, third party, or a public cloud. The data deletion may be performed by front-end filter. The data deletion may serve to drop, or remove, unnecessary information and/or reduce bandwidth, as a data package is traversing the outer layers of an institutional network.

A method in accordance with principles of the disclosure may be implemented by a computer and/or be automated.

A method in accordance with principles of the disclosure, may utilize a computer processor and one or more non-transitory computer-readable media storing computer executable instructions. The instructions, when executed by the computer processor, may automatically perform any of the steps described below.

A method in accordance with principles of the disclosure may utilize a computer processor, a front-end filter, and/or one or more non-transitory computer-readable media storing computer executable instructions. The instructions, when executed by the computer processor and/or front-end filter, may automatically analyze and/or process edge-layer data, e.g., in order to improve system functionality, as described herein. The method may include the steps of:
receiving the dataset in an edge layer of a network,
analyzing the dataset via the front-end filter, to identify deprioritized data points in the dataset;
subtracting the deprioritized data points from the dataset, thus generating a trimmed dataset; and
transferring the trimmed dataset to the platform layer; or importing the trimmed dataset into the platform layer.

The method may facilitate data transfer into a platform layer of a network. In some aspects, a computer processor may orchestrate some or all the aforementioned steps.

The mentioned deprioritized data points may be data points that need not be saved, e.g., in the edge layer.

In some aspects, the mentioned deprioritized data points may be data points that need not be processed, e.g., that need not be processed in the platform layer.

In some aspects, a computer processor may perform the task of subtracting the deprioritized data points from the dataset.

In some aspects, the front-end filter may perform the task of subtracting the deprioritized data points from the dataset.

In some aspects, a computer processor may instruct the front-end filter to perform the task of subtracting the deprioritized data points from the dataset.

In some aspects, transfer to the platform layer is performed subsequent to subtraction of selected data points from the dataset. By this method, network memory capacity and data channel utilization may be optimized and/or more intelligently utilized.

In some aspects, the front-end filter utilizes metadata tags to label datapoints. In some aspects, the filter may assign a metadata tag to deprioritized data points. In some aspects, the filter may assign a metadata tag to data points other than the deprioritized data points, for example points that should be transferred to, or imported into, the platform layer

In some aspects, deprioritized data points have a field type or a data descriptor that is of reduced value to the institution owning or managing the network. In some aspects, the data field is less valuable to the institution than other data fields in the same dataset. For example, if a network is owned or managed by a commercial entity, the deprioritized data points may belong to a data field not relevant to said commercial entity. For example, the deprioritized data points may be classified as personal data fields, while the commercial entity does not require storage of personal data fields. In other aspects, the deprioritized data points may be classified as institutional data fields, while the commercial entity does not require storage of institutional data fields.

In some aspects, the described method includes a further step of updating an existing dataset by replacing the existing dataset with the described trimmed dataset. In some aspects, the described method includes a further step of refreshing an existing dataset, using the trimmed dataset. In some aspects, the described method includes a further step of renewing an existing dataset, using the trimmed dataset. The existing dataset may be in the edge layer of the network. In other aspects, the existing dataset may be in the platform layer of the network. The existing dataset and the trimmed dataset may correspond to one another, for example by relating to the same entity or having overlapping data points.

In some aspects, an existing dataset may be sourced from a company that merged with another company. The existing dataset may no longer be valid. The existing dataset may need to be updated, replaced, refreshed or renewed with another dataset, which may be a trimmed dataset generated according to the described methods.

In some aspects, data may be retained only for a specified period of time, as per data laws or internal policies. In some aspects, refreshing or renewing a dataset may enable resetting the period of time that a dataset can be retained.

In some aspects, there is provided a method of reducing the size of a data package in an edge layer of network, using a front-end filter, as described herein. In some aspects, the edge layer is a demilitarized zone (DMZ) of a network.

In accordance with principles of the disclosure, there is provided a method for increasing available memory in an edge layer of a network, where the network stores data and has a default retention period for at least some datasets stored in the network. In some aspects, the edge layer is a demilitarized zone (DMZ) of a network. In various aspects, the memory may be hardware or software memory.

A method in accordance with principles of the disclosure may utilize a front-end filter and one or more non-transitory computer-readable media storing computer-executable instructions, in which the instructions, when executed by the front-end filter, automatically analyze the dataset and/or perform other functions described herein. The front-end filter may be located in an edge layer of the network. The method may include the following steps:
receiving the dataset by the edge layer of the network;
analyzing the dataset by the front-end filter to identify disposable data items or data points in the dataset; and
instructing a computer processor to remove the disposable data items or points from the dataset, upon passage of a specified time interval.

The referred-to disposable data items may be data points, data files, or data file components that need not be retained in the edge layer for more than a specified retention period. The specified retention period may be less than the default retention period. In some aspects, the data items need not be retained for the entire default retention period. The processor may be configured or programmed to remove the disposable data items upon expiration of the specified retention period.

By this method, available hardware memory, e.g., in an edge layer of the network, may be increased. In some aspects, available hardware storage, e.g., in an edge layer of the network, may be increased. In some aspects, channel utilization, e.g., in a platform layer of the network, may be optimized.

In some aspects, the front-end filter utilizes metadata tags to label datapoints. In some aspects, the filter may assign a metadata tag to disposable data points. In some aspects, the filter may assign a metadata tag to data points other than the disposable data points, for example points that should be transferred to the platform layer.

In some aspects, disposable data points belong to a data field or have a data descriptor that is of reduced value to the institution owning or managing the network. In some aspects, data of this type of data field need be retained, e.g., in the edge layer, only for a shorter interval by the institution than other data fields in the same dataset. For example, if a network is owned or managed by a commercial entity, the disposable data points may belong to a field type that the commercial entity does not need to retain for more than a short interval. For example, the disposable data points may be personal data fields, while the commercial entity does not require long-term storage of personal data information. Or the disposable data points may be institutional data fields, while the commercial entity does not require long-term storage of institutional data fields.

The dataset may also include non-disposable data points. The non-disposable data points may be points required to be retained in the edge layer for a time period at least as long as the default retention time period. The method may also include the step of subtracting the disposable data points from said dataset. Thus, a trimmed dataset is generated.

It will be appreciated that a network may have different default retention time periods for different types of datasets. In some aspects, the described default retention time period may refer to a default time period for a dataset of the type being processed by the system. For example, federal statutes may specify maximal time periods for retention of personal data. Those skilled in the art are capable of identifying such statutes and determining default data retention periods accordingly.

In some aspects, transfer to the platform layer is performed subsequent to subtraction of disposable data points from the dataset. By this method, network memory capacity and data channel utilization may be more intelligently utilized.

In some aspects, the described method may also include the step of updating an existing dataset by replacing the existing dataset with the trimmed dataset. In some aspects, the existing dataset may be in the edge layer. In other aspects, the existing dataset may be in the platform layer.

In some aspects, the described method may also include the step of refreshing an existing dataset by replacing the existing dataset with the trimmed dataset. In some aspects, the existing dataset may be in the edge layer. In other aspects, the existing dataset may be in the platform layer.

In some aspects, the described method may also include the step of renewing an existing dataset by replacing the existing dataset with the trimmed dataset. In some aspects, the existing dataset may be in the edge layer. In other aspects, the existing dataset may be in the platform layer.

In some aspects, the described method is followed by the step of transferring a modified dataset obtained by the initial method steps into a platform layer of a network.

In other aspects, there is provided a method for increasing available memory in an edge layer of a network, where the network stores data and has a default retention period for at least some datasets stored in the network. In some aspects, the memory is hardware memory. In other aspects, the memory is software memory.

In other aspects, there is provided a method for increasing available storage capacity in an edge layer of a network, where the network stores data and has a default retention period for at least some datasets stored in the network. In some aspects, the storage capacity is hardware storage. In other aspects, the storage capacity is software storage.

In some aspects, the method may utilize a front-end filter disposed in an edge layer of the network and one or more non-transitory computer-readable media storing computer-executable instructions. In some aspects, the instructions, when executed by the front-end filter, may automatically analyze the dataset. The method may include the steps of:
receiving the dataset in the edge layer of the network;
analyzing the dataset by the front-end filter to identify disposable data files or file components in the dataset that are greater than a specified threshold size; and
instructing a computer processor located in the edge layer to remove the disposable data files or file components from dataset, upon expiration of a specified retention time period.

The specified retention time period may be less than the described default retention time period.

By this method, available hardware memory, e.g., in an edge layer of the network, may be increased. In some aspects, available hardware storage capacity, e.g., in an edge layer of the network, may be increased. By this method, available software memory, e.g., in an edge layer of the network, may be increased. In some aspects, available software storage capacity, e.g., in an edge layer of the network, may be increased. In some aspects, channel utilization, e.g., in a platform layer of the network, may be optimized.

Data may have a limited lifetime, for example as a result of regulations that stipulate a maximum lifetime for data retention. The described methods may enable resetting of data lifetime, starting from an earlier timepoint and thus expiring at a later timepoint.

In some aspects, data files or file components greater than a specified threshold size are only required to be retained temporarily in a network. For example, color copies of certain type of photographs and diagrams (e.g., computer-aided design drawings) need only be retained until quality checks or verifications are performed, after which corresponding black and white, or grayscale, copies are sufficient.

In some aspects, the front-end filter utilizes metadata tags to label data files or file components. In some aspects, the filter may assign a metadata tag to disposable data files or file components. In some aspects, the filter may assign a metadata tag to data files or file components other than the disposable data files or file components, for example files or file components that should be transferred to the platform layer.

The dataset may also include non-disposable data files or file components. The non-disposable data files or file components may be points that need be retained, e.g., in the edge layer, for at time period at least as long as the default retention time period. The method may also include the step of subtracting the disposable data files or file components from said dataset. Thus, a trimmed dataset is generated.

In some aspects, the described method is followed by the step of transferring a modified or trimmed dataset obtained by the initial method steps to a platform layer of a network.

In some aspects, the described method may include a further step of updating an existing dataset by replacing the existing dataset with the trimmed dataset. In some aspects, the existing dataset may be in the edge layer. In other aspects, the existing dataset may be in the platform layer.

In some aspects, the described method may include a further step of refreshing an existing dataset by replacing the existing dataset with the trimmed dataset. In some aspects, the existing dataset may be in the edge layer. In other aspects, the existing dataset may be in the platform layer.

In some aspects, the described method may include a further step of renewing an existing dataset by replacing the existing dataset with the trimmed dataset. In some aspects, the existing dataset may be in the edge layer. In other aspects, the existing dataset may be in the platform layer.

In some aspects, the initial dataset is provided by a user computer system. As used herein, the term “user” may refer to an entity or individual associated with the described network. In some aspects, a user may be a computing device user, a phone user, a mobile device application user, a customer of an entity or business, a system operator, and/or employee of an entity (e.g., a financial institution). In some aspects, users may be one or more of associates, employees, agents, contractors, sub-contractors, third-party representatives, customers, or the like.

As used herein, the term “entity” may be used to include any organization or collection of users that may manage the described network or system. An entity may refer to a business, company, or other organization that either maintains or operates the system or requests use and accesses the system. A non-limiting example of an entity an organization that processes financial transactions including, but not limited to, banks, credit unions, savings and loan associations, investment companies, stock brokerages, management firms, insurance companies and the like. In some aspects, an entity may be a customer, e.g., a customer of an organization that processes financial transactions. In other aspects, an entity may be a business, organization, government branch, or the like that is not a financial institution.

Computer systems and processors utilized in the described methods and systems may include one or more communication components, one or more processor components, and one or more memory components. The one or more processor components may be operatively coupled to the one or more communication components and the one or more memory components. As used herein, the term “processor” generally includes circuitry used for implementing the communication and/or logic functions of a particular system. For example, a processor component may include a digital signal processor, a microprocessor, and various analog-to-digital converters, digital-to-analog converters, and other support circuits and/or combinations of the foregoing. Control and signal processing functions of the system are allocated between these processor components according to their respective capabilities. The one or more processor components may include functionality to operate one or more software programs based on computer-readable instructions thereof, which may be stored in the one or more memory components.

The one or more processor components may use the one or more communication components to communicate with the network and other components on the network, such as, but not limited to, one or more machine learning engines and one or more computer processors. As such, the one or more communication components may include a wireless transceiver, modem, server, electrical connection, electrical circuit, or other component for communicating with other components on the network. The one or more communication components may further include an interface that accepts one or more network interface cards, ports for connection of network components, Universal Serial Bus (USB) connectors, and the like.

The computer processor(s) may include components similar to one or more communication components, one or more processor subcomponents, one or more memory components, and computer-readable instructions.

A computer system or processor may alternatively be referred to herein as an “engine,” “server” or a “computing device.” A computer system or processor may be any computing device described herein, such as the computing devices running on a computer, smart phones, smart cars, smart cards, and any other mobile device described herein. Elements of computer systems and processors may be used to implement various aspects of the systems and methods disclosed herein.

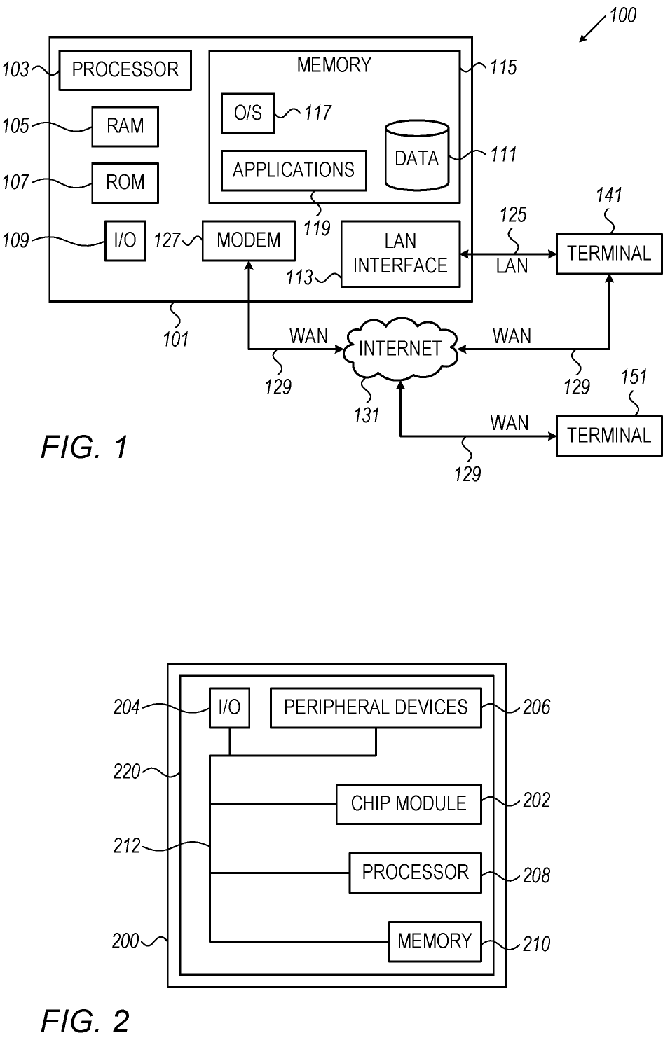

The aforementioned processing device or computer processor may be a computer, as described in more detail in FIG. 1, optionally including any of the components and elements described for FIG. 1.

In some aspects, the processing device or computer processor may be a computer, as described in more detail in FIG. 2, optionally including any of the components and elements described for FIG. 2.

The described front-end filter and/or computer processor may be programmed or configured to automatically monitor the network or data mesh, e.g., on an ongoing basis, to: (a) determine when a new dataset is received by the network or data mesh; (b) automatically process the new dataset, according to any of the described methods.

In some aspects of the described methods, individual data fields or records are evaluated for compliance with a particular condition. In some aspects, the data is evaluated positively, for example by tagging records or fields that meet the specified condition. In other aspects, the data is evaluated negatively, for example by tagging records or fields that violate the condition.

In some aspects of the described method and systems, folders are utilized to organize and view data rules, rule sets, and metrics. In other aspects, folders are used to organize data rules, rule sets, and metrics based on various business tasks. In other aspects, data rules, rule sets, and metrics are organized by data sources or systems.

The mentioned computer processor used to process a dataset may utilize a machine learning engine. The machine learning engine may include a modality, non-limiting examples of which are natural language processing, trained neural network models, deep learning models, supervised machine learning models, and artificial intelligence models.

In some aspects, the described system may be configured or programmed to utilize a machine learning engine to create one or more data rules for designating datapoints or data files or file components as disposable or non-disposable data points. The machine learning engine may be configured for receiving and analyzing incoming datasets and one or more historical data rules databases; and generating the data rule set based on an analysis of the combined data. In some embodiments, the datapoint designation rule set generated by the machine learning engine may comprise an initial rule set to be further optimized by the system. In some embodiments, datapoint designation rules may be initially set by a maintaining entity or from a previously executed data transfer and stored in a master rule database.

Alternatively or in addition, the system may be configured or programmed to utilize a machine learning engine to create one or more data rules for designation of datapoints, files, or file components; or for transferring a trimmed dataset to the platform layer. In some aspects, the data transfer rule set may define a configuration of data channels and/or associated data for transferring the data from the edge layer to the platform layer over available data channels. In some embodiments, the data transfer rule set generated by the machine learning engine may comprise an initial rule set to be further optimized by the system. In some embodiments, the data transfer rule set may provide predetermined guidelines for which transferred data or device employ a shared data channel and which data or devices are restricted from sharing data channels. In some embodiments, data transfer rules may be initially set by a maintaining entity or from a previously executed data transfer and stored in a master rule database.

In some aspects, the system may be configured to calculate optimal data rules for designation of datapoints, files, or file components, based on the incoming datasets. The system may include a quantum optimization engine configured for processing the data collected from user devices in the context of existing data. The quantum optimization engine may receive the initial data rule set along with the dataset itself and process this information to determine optimal data rules. The quantum optimization engine may be configured to utilize one or more quantum algorithms to determine data rules, based on the input. Non-limiting examples of quantum algorithms utilized by the system include Fourier transform-based algorithms, amplitude amplification-based algorithms, quantum walk-based algorithms, and the like The system may be configured to employ a hybrid quantum/classical algorithm.

In some aspects, the described machine learning modality is a quantum optimization engine. The quantum optimization engine may be configured to utilize one or more quantum algorithms to process the inputted data. Non-limiting examples of quantum algorithms are selected from, for example, Fourier transform-based algorithms, amplitude amplification-based algorithms, quantum walk-based algorithms, and the like. In one embodiment, the system is configured to employ a hybrid quantum/classical algorithm. The quantum optimization engine may input an initial data rule set from existing datasets and use it to process the new dataset(s). The engine may further hone the data rules, using the new data, thus further optimizing the data rules.

In some aspects, the described machine learning engine, system, or algorithm may include:
at least one memory device with computer-readable program code stored thereon;
at least one communication device;
at least one processing device operatively coupled to the at least one memory device and the at least one communication device, in which executing the computer-readable code is configured to cause the at least one processing device to:
   receive a dataset for analysis by a regulated machine learning model and a data rule machine learning engine;
   detect, via the regulated machine learning model, data quality metrics of the input data, in which the metrics include rules, regulations, policies, predetermined thresholds, and/or known reference data and patterns;
   formulate draft data rules using the machine learning engine, e.g., to identify and subtract deprioritized or disposable data points, files, or file components from the dataset;
   test the draft data rules on the dataset;
   determine, via the machine learning engine, an incremental learning threshold based on the received data rules;
   retrain the regulated machine learning model to incorporate the results of testing the draft data rules on the dataset, as per the incremental learning threshold;
   determine, via the regulated machine learning model, an optimization learning adjustment for optimizing accuracy of the regulated machine learning model based on received dataset; and
   balance the optimization learning adjustment with the incremental learning threshold to optimize retraining of the machine learning model within boundaries of the incremental learning threshold.

In some aspects, the system may be configured or programmed to wait for periods of lower data traffic, before transferring deprioritized data points across, or within, the network. In this way, the system intelligently optimizes which data is transferred over the network for additional processing in the platform layer and which data is cached for offline processing to save data transfer cost and processing power of the application server.

Alternatively, the system may be configured or programmed to not transfer deprioritized data points within the network. In some aspects, the system may be programmed to deem redundant deprioritized or disposable data points. These new data points may be discarded, archived, or placed in low-priority storage. Alternatively, the system may be programmed to subtract from the new dataset deprioritized or disposable data points.

The method may include the additional step of generating data rules for the new dataset, for example to transfer only prioritized or non-disposable data points, or data files or file components not greater than a specified threshold size. Artificial intelligence or a machine learning algorithm or engine may be used to generate the data rules.

A machine learning engine may be configured to input data to a quantum optimization engine to provide an output decision of optimized data trimming—and/or an optimized data transfer configuration—to a data flow orchestration engine to execute an optimized data transfer. In some aspects, the machine learning engine may be configured to generate a data rule set, including rules and computational scoring logic, to be inputted into the quantum optimization engine. In some aspects, the rules and/or logic may be provided to the engine as an initial starting point or recommendation.

In some aspects, the artificial intelligence or machine learning engine may be configured to continually optimize data rules, based on results with previous datasets. In some aspects, data trimming protocols may be based on optimized data transfer configurations.

In some aspects, a machine learning engine may be configured to input data to a quantum optimization engine to provide an output decision of optimized data retention periods-and/or an optimized data transfer configuration-to a data flow orchestration engine to execute an optimized data transfer. In some aspects, the machine learning engine may be configured to generate a data rule set, including rules and computational scoring logic, to be inputted into the quantum optimization engine. In some aspects, the rules and/or logic may be provided to the engine as an initial starting point or recommendation.

In some aspects, data retention protocols are based on maximizing usage of available data channels while complying with relevant data retention regulations. In some aspects, the system is configured to use machine learning to maximize hardware memory usage by continually refining data retention periods, based on experience with previous datasets. In some aspects, the system is configured to use machine learning to maximize software memory usage by continually refining data retention periods, based on experience with previous datasets.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative, and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

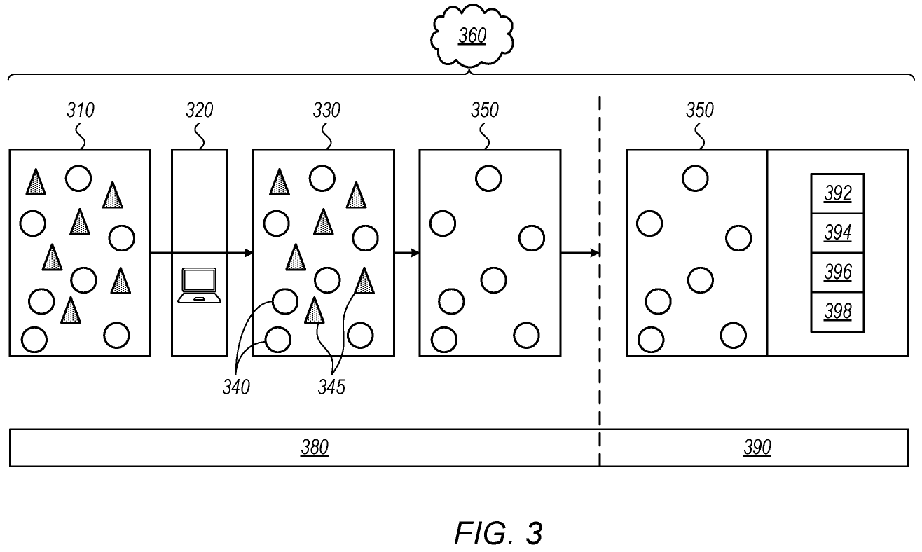

FIG. 3 is a diagram depicting a data filtering process, in accordance with embodiments of the disclosure. As illustrated in FIG. 3, new dataset 310 is received by edge layer 380 of network 360 and passes through front-end filter 320. Front-end filter 320 annotates new dataset 310 to generate annotated dataset 330, in which prioritized data points 340 and deprioritized data points 345 are marked. Front-end filter 320 or a computer processor (not depicted) removes deprioritized data points 345 to generate trimmed dataset 350. Trimmed dataset 350 is transferred to platform layer 390. The platform layer 390 may include an application server 392 that receives data from user devices and/or a gateway (not depicted) of the edge layer 380. The platform layer 390 may also include a data transformation module 394, configured for transforming data transmitted between the edge layer 380 and enterprise layer (not depicted); an analytics module 396 and an operations module 398 for processing data at the platform layer 820; and/or a user interface (not depicted). All components may communicate via network 360. By this method, the new dataset 310 may be efficiently transferred to platform layer 390.

The network 360 illustrated in FIG. 3, through which the components communicate, may be a global area network (GAN), such as the Internet, a wide area network (WAN), a local area network (LAN), or any other type of network or combination of networks. The network 360 may provide for wireline, wireless, or a combination of wireline and wireless communication between systems, services, components, and/or devices on the network 360.

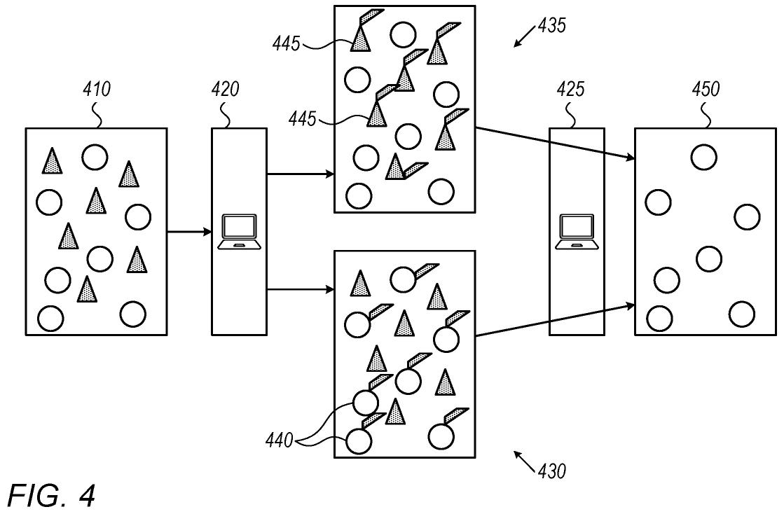

FIG. 4 is a simplified diagram depicting a data filtering process and system, in accordance with embodiments of the disclosure. As illustrated in FIG. 4, new dataset 410 is received by network (not depicted) and passes through front-end filter 420. Front-end filter 420 annotates new dataset 410 to generate either positively annotated dataset 435, in which deprioritized data points 445 are marked with metadata tags; or negatively annotated dataset 430, in which prioritized data points 440 are marked with metadata tags. Either tagged or untagged data points are removed, as appropriate, by either front-end filter 420 or another processor 425; only the latter possibility is depicted in FIG. 4. All components may communicate via a network (not depicted).

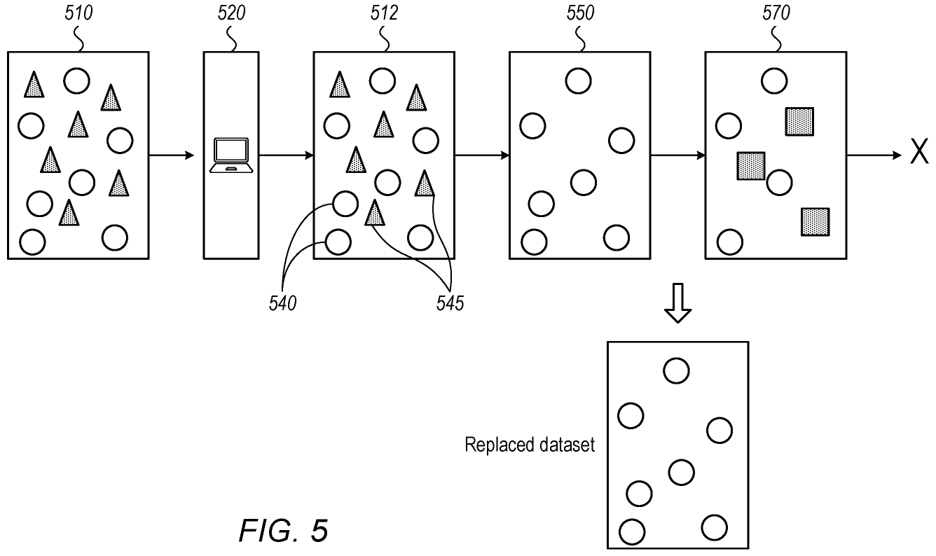

FIG. 5 is a simplified diagram depicting a data filtering and replacement process, in accordance with embodiments of the disclosure. As illustrated in FIG. 5, new dataset 510 is received by network (not depicted) and passes through front-end filter 520. Front-end filter 520 annotates new dataset 510 to generate annotated dataset 512, in which prioritized data points 340 and deprioritized data points 345 are marked; and then trimmed dataset 550. Trimmed dataset 550 replaces existing dataset 570; thus, existing dataset 570 is deleted, and only trimmed dataset 550 remains. Trimmed dataset 450 is thus generated. All components may communicate via a network (not depicted).

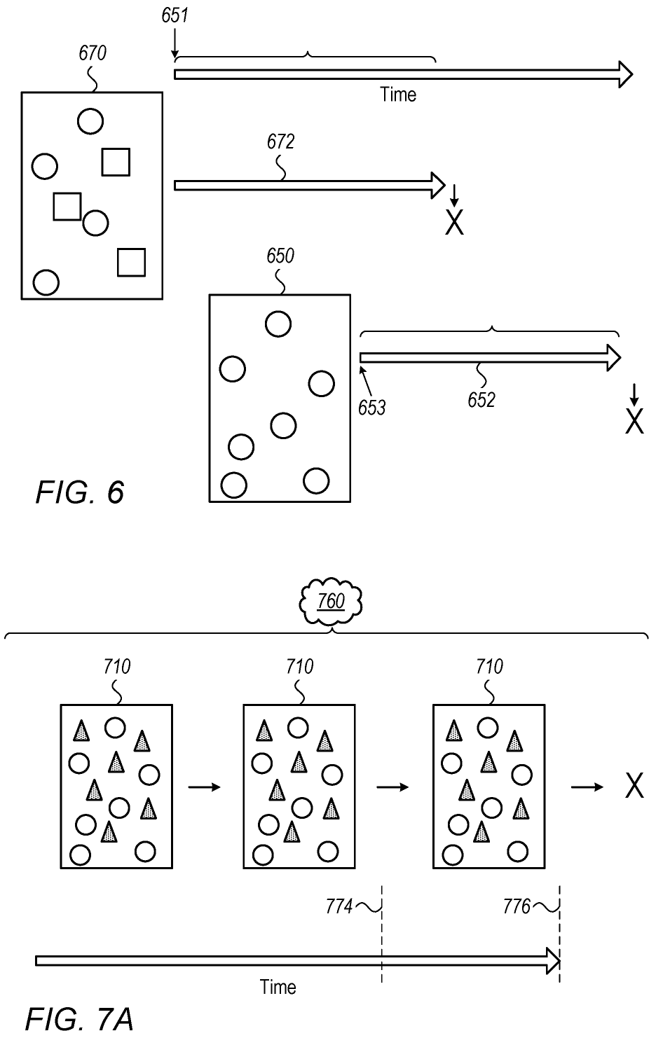

FIG. 6 is a diagram depicting the temporal fate of datasets after filtering by front-end filter (not depicted), in accordance with embodiments of the disclosure. Timelines are indicated by large arrows, depicting the effect of replacing an existing dataset 670 with a trimmed dataset 650 generated by earlier data filtering process steps (not depicted) Existing dataset 670 may be slated to exist, e.g., in hardware memory, only for earlier lifetime 672, starting with initial data storage time 651 and continuing for the allowable retention time period (indicated by bracket). Replacing existing dataset 670 by a replacement dataset, in this case trimmed dataset 650, may enable resetting the data lifetime to later lifetime 652, starting with data replacement time 653 and continuing for the allowable retention time period. Data lifetime may be extended while simultaneously improving resource utilization.

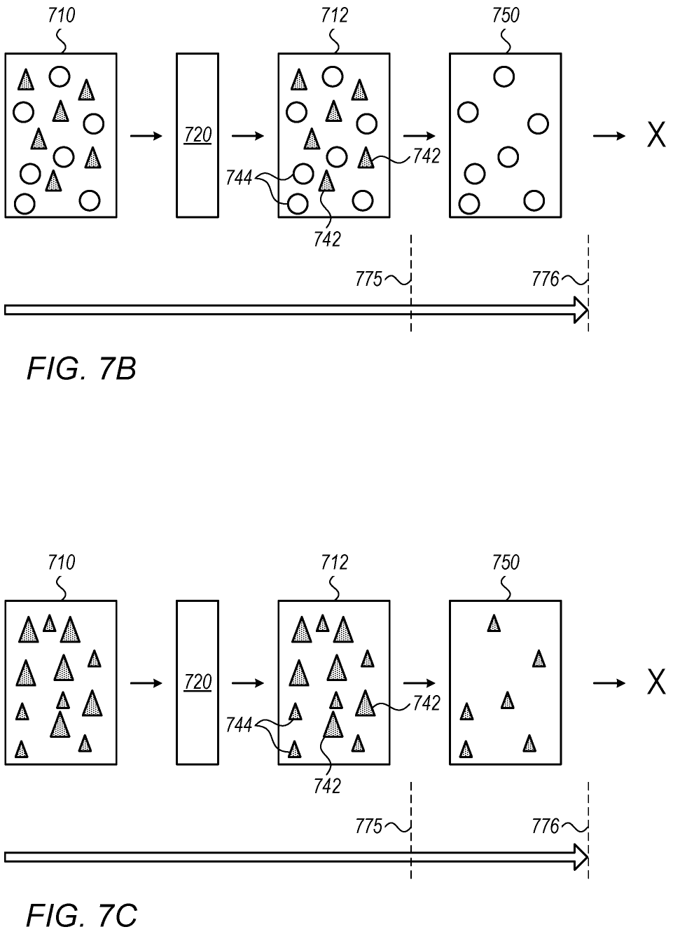

FIG. 7A is a diagram depicting the fate of a dataset 710 in the absence of data filtering. The large arrow is a timeline. Dataset 710 remains in network 760, through intermediate time point 774, until it is disposed of at default timepoint 776, which coincides with conclusion of the default retention time period for dataset 710. All components may communicate via network 760.

FIG. 7B is a diagram depicting the fate of a dataset 710 after filtering by front-end filter 720, in accordance with embodiments of the disclosure. The large arrow is a timeline. Filtering by front-end filter 720 generates annotated dataset 712, in which different types of data points, data files, or data file components (referred to collectively herein as “data points”, for convenience) are designated by front-end filter 720 as disposable data points 742 or non-disposable data points 744. Annotated dataset 712 is retained until specified timepoint 775, which coincides with conclusion of a specified retention time period for disposable data points, after which disposable data points 742 are removed from the dataset to generate trimmed dataset 750. Trimmed dataset 750 is retained until default timepoint 776, which coincides with conclusion of the default retention time period for dataset 710. All components may communicate via a network (not depicted).

FIG. 7C is a diagram depicting the fate of a dataset 710 after filtering by front-end filter 720, in accordance with embodiments of the disclosure. The large arrow is a timeline. Filtering by front-end filter 720 generates annotated dataset 712, in which data files or file components of different sizes are designated by front-end filter 720 as disposable data files to components 742 or non-disposable data files or components 744. Front-end filter 720 generates annotated dataset 712, in which files or file components of having a size greater than a specified threshold size are designated as disposable data points 742; whereas files or file components of having a size not greater than the specified threshold size are designated as non-disposable data points 744. Annotated dataset 712 is retained until specified timepoint 775, which coincides with conclusion of a specified retention time period for disposable files or components; after which disposable data files or components 742 are removed from the dataset to generate trimmed dataset 750. Trimmed dataset 750 is retained until default timepoint 776, which coincides with conclusion of the default retention time period for dataset 710. All components may communicate via a network (not depicted).

In some aspects, the system may be configured or programmed to transmit a portion of data (e.g., prioritized datapoints, data files, or data files components; referred to collectively herein as “data points”, for convenience) and not transmit another portion of data points (e.g., deprioritized datapoints), where the data that is not transmitted is instead temporarily cached for later processing or transmission. In this way, the system intelligently optimizes which data is transferred over the network for additional processing in the platform layer and which data is cached for offline processing, e.g., to save data transfer cost and processing power of an application server.

As will be appreciated by one of ordinary skill in the art, the described systems may be embodied as an apparatus (including, for example, a system, a machine, a device, a computer program product, and/or the like), as a method (including, for example, a process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with intelligently controlling data transfers between network connected devices and a platform layer application server.

It will be understood that any suitable computer-readable medium may be utilized The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for intelligently controlling data transfers between network connected devices and a platform layer application server, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s)

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

In some aspects of the described methods and systems, a regulated machine learning (ML) model is utilized. The regulated ML model is designed to make incremental learning adjustments in tandem with the determinations made by the machine learning engine and communicated to the regulated ML model. The machine learning engine may access data outputted from test applications of draft data rules, and may be trained to use data from the test transfers to collectively formulate and approve incremental learning adjustments with the regulated ML model. The regulated ML model and the machine learning engine may consider input data patterns, output data patterns, thresholds for model performance, and/or distributions of identified patterns between different ML models.

One of ordinary skill in the art will appreciate that the steps shown and described herein may be performed in other than the recited order and that one or more steps illustrated may be optional. The methods of the above-described aspects may involve the use of any suitable elements, steps, computer-executable instructions, or computer-readable data structures. In this regard, other aspects described herein can be partially or wholly implemented on a computer-readable medium, for example, by storing computer-executable instructions or modules or by utilizing computer-readable data structures.

Thus, methods, systems, apparatuses, and computer program products may improve and optimize data rules, such as rules for data prioritization, data retention time periods, and data transfers. Persons skilled in the art will appreciate that the present invention can be practiced by other than the described embodiments, which are presented for purposes of illustration rather than of limitation.

What is claimed is:

1. A method of transferring a dataset into a platform layer of a network, the method utilizing a front-end filter disposed in an edge layer of said network and one or more non-transitory computer-readable media storing computer-executable instructions, wherein the instructions, when executed by the front-end filter, automatically analyze said dataset, the method comprising the steps of:
said edge layer of said network receiving said dataset,
said front-end filter analyzing said dataset to identify deprioritized data points in said dataset, wherein said deprioritized data points need not be transferred to said platform layer;
subtracting said deprioritized data points from said dataset, thereby generating a trimmed dataset; and
transferring said trimmed dataset to said platform layer.

2. The method of claim 1, wherein said front-end filter assigns a metadata tag to said deprioritized data points.

3. The method of claim 1, wherein said front-end filter assigns a metadata tag to data points that are not said deprioritized data points.

4. The method of claim 1, wherein said network is owned or managed by a commercial entity, and said deprioritized data points belong to a data field not relevant to said commercial entity.

5. The method of claim 4, wherein said deprioritized data points are personal data fields.

6. The method of claim 4, wherein said deprioritized data points are institutional data fields.

7. The method of claim 1, said method further comprising the step of updating an existing dataset in said edge layer by replacing said existing dataset with said trimmed dataset.

8. The method of claim 1, said method further comprising the step of refreshing an existing dataset in said edge layer by replacing said existing dataset with said trimmed dataset.

9. A method of increasing available memory in an edge layer of a network, said network storing data and having a default data retention time period, the method utilizing a front-end filter disposed in an edge layer of said network and one or more non-transitory computer-readable media storing computer-executable instructions, wherein the instructions, when executed by the front-end filter, automatically analyze an incoming dataset, the method comprising the steps of:
said edge layer of said network receiving said dataset,
said front-end filter analyzing said dataset to identify disposable data points in said dataset, wherein said disposable data points need not be retained in said edge layer for more than a specified retention time period, said specified retention time period being less than said default data retention time period;
instructing a computer processor disposed in said edge layer to remove said disposable data points from said dataset, upon expiration of said specified retention time period.

10. The method of claim 9, wherein said front-end filter assigns a metadata tag to said disposable data points.

11. The method of claim 9, wherein said front-end filter assigns a metadata tag to data points that are not said disposable data points.

12. The method of claim 9, wherein said network is owned or managed by a commercial entity, and said disposable data points are not needed by said commercial entity for more than said specified retention time period.

13. The method of claim 9, wherein said dataset comprises non-disposable data points, wherein said non-disposable data points need be retained in edge platform layer for said default retention time period; said method further comprising the step of subtracting said disposable data points from said dataset, thereby generating a trimmed dataset.

14. The method of claim 13, said method further comprising the step of updating an existing dataset in said edge layer by replacing said existing dataset with said trimmed dataset.

15. The method of claim 13, said method further comprising the step of refreshing an existing dataset in said edge layer by replacing said existing dataset with said trimmed dataset.

16. A method of increasing available memory in an edge layer of a network, said network storing data and having a default data retention time period, the method utilizing a front-end filter disposed in an edge layer of said network and one or more non-transitory computer-readable media storing computer-executable instructions, wherein the instructions, when executed by the front-end filter, automatically analyze an incoming dataset, the method comprising the steps of:
said edge layer of said network receiving said dataset;
said front-end filter analyzing said dataset to identify disposable data files or file components in said dataset, wherein said disposable data files or file components are greater than a specified threshold size; and
instructing a computer processor disposed in said edge layer to remove said disposable data files or file components from said dataset, upon expiration of a specified retention time period, said specified retention time period being less than said default data retention time period.

17. The method of claim 16, wherein said front-end filter assigns a metadata tag to said disposable data files or file components.

18. The method of claim 16, wherein said front-end filter assigns a metadata tag to data files or file components that are not said disposable data files or file components.

19. The method of claim 16, wherein said dataset comprises non-disposable data files or file components, wherein said non-disposable data files or file components are smaller than said specified threshold size; said method further comprising the step of subtracting said disposable data files or file components from said dataset, thereby generating a trimmed dataset.

20. The method of claim 19, said method further comprising the step of updating an existing dataset in said edge layer by replacing said existing dataset with said trimmed dataset.

21. The method of claim 19, said method further comprising the step of refreshing an existing dataset in said edge layer by replacing said existing dataset with said trimmed dataset.
